(19) United States
(12) Patent Application Publication
(10) Pub. No.: US 2015/0178799 A1
(43) Pub. Date: Jun. 25, 2015

(54) SYSTEM AND METHOD OF FUEL FILLING TO MINIMIZE FUEL COST

(71) Applicants: Yu Cheng, Shanghai (CN); Mengjiao Wang, Shanghai (CN); Wen-Syan Li, Fremont, CA (US)

(72) Inventors: Yu Cheng, Shanghai (CN); Mengjiao Wang, Shanghai (CN); Wen-Syan Li, Fremont, CA (US)

(73) Assignee: SAP AG, Walldorf (DE)

(21) Appl. No.: 14/134,567

(22) Filed: Dec. 19, 2013

(51) Int. Cl. G06Q 30/02; G06Q 50/06

(52) U.S. Cl. CPC G06Q 30/0283; G06Q 50/06

(57) ABSTRACT

In an example, a method for determining quantities of fuel to dispense at a plurality of terminals along a transit route of a vehicle includes identifying a plurality of terminals along the transit route, each terminal of the plurality of terminals have an associated cost-per-unit of fuel dispensed; initializing a set of candidate fueling scenarios, each candidate fueling scenario including an initial array of values, each value in the array of values indicating a quantity of fuel to dispense to the vehicle at one of the plurality of terminals along the transit route; iteratively, using at least one processor, modifying the set of candidate scenarios; identifying the candidate scenario of the set of candidate scenarios with the lowest total fuel cost; and transmitting for display, the quantity of fuel to dispense at each of the plurality of terminals according to the identified lowest total fuel cost candidate scenario.

### TECHNICAL FIELD

This patent document pertains generally to minimization problems, and more particularly, but not by way of limitation, to a system and method of fuel filling to minimize fuel cost.

### BACKGROUND

During a planned trip among a plurality of stops, a vehicle may need to fill up on fuel multiple times. The price of fuel at each stop may vary and therefore the total cost of fuel for the trip may also vary depending on how much fuel is filled up at each stop. Additionally, different vehicles consume (e.g., use) fuel at different rates. Accordingly, there may be many different fuel costs scenarios for a given trip.

### BRIEF DESCRIPTION OF DRAWINGS

Some embodiments are illustrated by way of example and not limitation in the figures of the accompanying drawings in which:

FIG. 1 is a system diagram, according to various example.

FIG. 2 is a block diagram, according to various examples.

FIG. 3 is a flow chart illustrating a differential evolution method, according to various examples.

FIG. 4 illustrates a block diagram of a chromosome, according to various examples.

FIG. 5 illustrates a user interface of a browser window, according to various examples

FIG. 6 is a flow chart illustrating a method, according to various examples.

FIG. 7 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Consider a vehicle that is on a transit path through a plurality of stops (e.g., cities, states, countries). In various examples, the vehicle may be an aircraft, cargo, trailer, truck, maritime vessel, etc. Much of the cost of the trip may be based on the amount of fuel used during the trip. Accordingly, a person may determine how much fuel should be filled up at each stop of the trip. One solution is to fill up the vehicle to its capacity at each stop. However, in such an solution there is no control for costs.

In various examples, in order to minimize costs, different amounts of fuel may be filled up at the different stops. Thus, the problem may be generalized as a constraint minimization problem. Some factors that may be considered in solving this minimization problem may include, but are not limited to, the price difference for fuel from stop to stop, the vehicle should be filled to reach their next destination, the vehicle should not be too filled as it increases weight and thus may lower fuel efficiency, and different vehicles have different fuel consumption functions in regard to weight, speed, and other parameters.

In various examples, a fuel optimization system is described that determines, for a given transit route, the amount of fuel to fill up at each stop along the transit route. The fuel optimization system may include three general operations: (1) data collection of vehicle types, local fuel prices, travel distances; (2) applying a differential evolution algorithm using the collected data and defined operational contains and objectives to optimize fuel filling; (3) and visualizing the results of the differential evolution algorithm.

In various examples, utilization of the system may result in a minimal fuel cost while maintain a safe fuel remainder at each stop along a transit route. Additionally, when differential evolution is used and the relationship between vehicle weight and consumption of fuel is known, the system may be used regardless of the type of vehicle. Thus, in contrast to linear programming methods, using only predefined types of vehicles may not be needed.

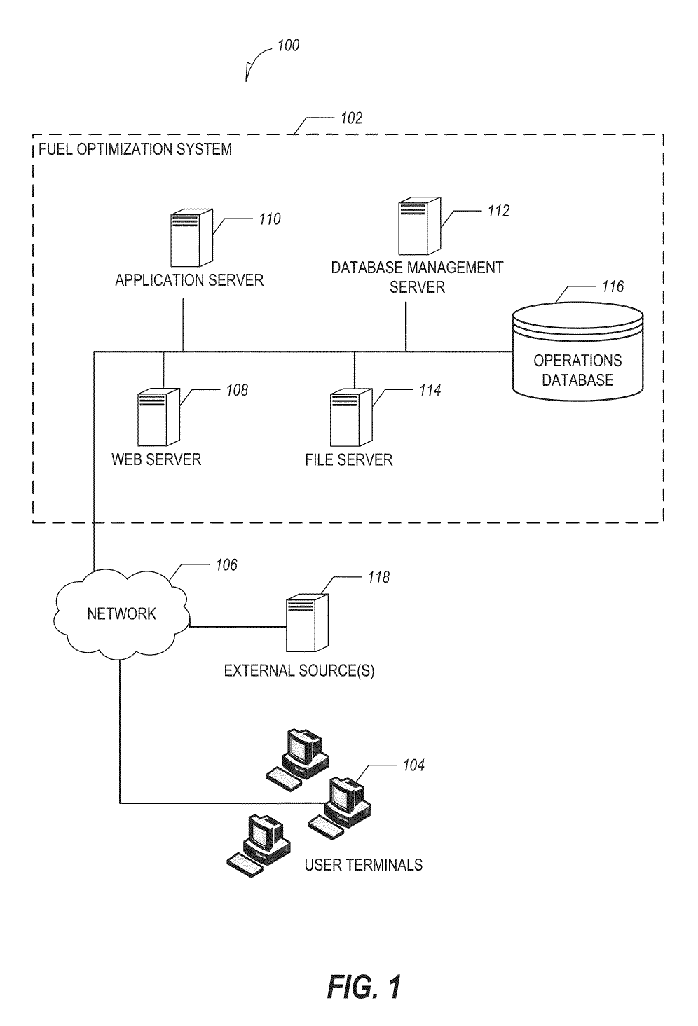

FIG. 1 illustrates a system diagram 100, according to various example embodiments. Diagram 100 includes, fuel optimization system 102, user terminal(s) 104, network 106, web server 108, application server 110, database management server 112, file server 114, operations database 116, and externals source(s) 118. In various examples, the components illustrated may be utilized to determine the amount of fuel to fill-up at each stop along a transit route. For example, a user may use user terminal 104 to load an application (e.g., thin-client served by file optimization system 102, local client implementing the functions of file optimization system, etc.) and input a transit route with one more stops. Fuel optimization system may calculate the fuel to use at each stop using data stored in operations database 116. Then, the results may be presented on the user terminal for the user. More detail of the components and their functions is discussed below.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices coupled to network 106 may be coupled to network 106 via one or more wired or wireless connections.

Web server 108 may communicate with file server 114 to publish or serve files stored on file server 114. Web server 108 may also communicate or interface with the application server 110 to enable web-based presentation of information. For example, application server 110 may consist of scripts, applications, or library files that provide primary or auxiliary functionality to web server 108 (e.g., multimedia, file transfer, or dynamic interface functions).

In addition, application server 110 may also provide some or the entire interface for web server 108 to communicate with one or more of the other servers in fuel optimization system 102 (e.g., database management server 112). Web server 108, either alone or in conjunction with one or more other computers in fuel optimization system 102, may provide a user-interface to input transit stops and a type of vehicle. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™)

User terminal 104 may be a personal computer or mobile device. In an embodiment, user terminal 104 includes a client program to interface with fuel optimization system 102. The client program may include commercial software, custom software, open source software, freeware, shareware, or other types of software packages. In an embodiment, the client program includes a thin client designed to provide query and data manipulation tools for a user of user terminal 104. The client program may interact with a server program hosted by, for example, application server 110. Additionally, the client program may interface with database management server 112.

Operations database 116 may be composed of one or more logical or physical databases. For example, operations database 116 may be viewed as a system of databases that when viewed as a compilation, represent an “operations database.” Sub-databases in such a configuration may include a vehicle tank capacity database, a distances database, a fuel prices database, a safety threshold database, and a fuel consumption function database. Operations database 116 may be implemented as a relational database, a centralized database, a distributed database, an object oriented database, or a flat database in various embodiments.

During operation, data from multiple data sources is imported into operations database 116. Data sources may exist within an organization offering the fuel optimization systems or exist at an external source, such as commercial database or a public record source. The data may be imported and stored in the operations database on a scheduled basis, such as weekly, monthly, quarterly, or some other regular or periodic interval to maintain current data. Alternatively, the data may be imported on-demand (e.g., each time a user wants to determine the amount of fuel to use).

After data importation, the data may be standardized and then stored in operations database 116. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats, name formats, and address fields).

While illustrated as separate components in diagram 100, the various components may be combined or split into additional servers. Additionally, one or more of the components may not be utilized during operation of the present disclosure. Additionally, the components may be rearranged. For example, a user terminal may be part of the file optimization system instead of communicating through the web server.

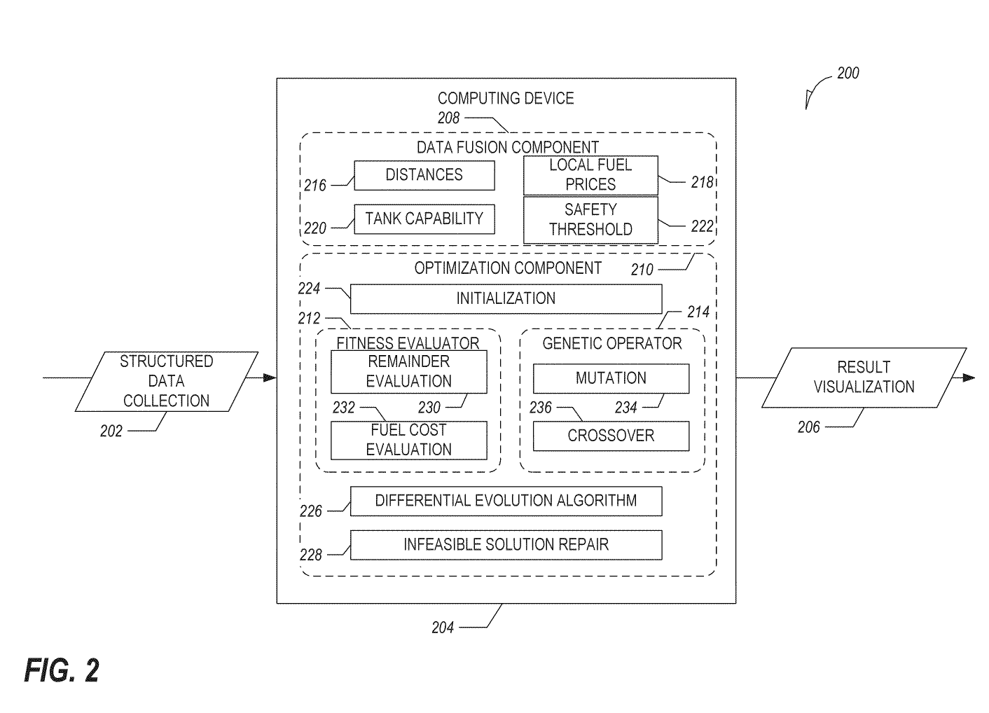

FIG. 2 illustrates block diagram 200 according to various examples of the disclosure. Illustrated is structured data collection 202, computing device 204, result visualization 206, data fusion component 208, optimization component 210, fitness evaluation 212, genetic operator 214, distances data 216, local fuel prices data 218, tank capability data 220, safety threshold data 222, initialization operation 224, differential evolution algorithm 226, infeasible solution repair operation 228, remainder evaluation operation 230, fuel cost evaluation operation 232, mutation operation 234, and crossover operation 236. The names of the data, components, and operations are for illustration purposes and other names may be used without departing from the scope of this disclosure. In various examples, the data, component, and operations may be spread across multiple computing devices.

The operations and functionality discussed below may be implemented by computing instructions stored on a storage device that are executed by one or more processors of the computing device. In various examples, the storage device is a non-transitory storage medium. In various examples, non-transitory refers to excluding propagating signals and does not refer to whether or not the storage device is mobile.

In various examples, structured data collection 202 is data that has been collected for data fusion component 208 (e.g., from internal or external sources). Data fusion component 208 may retrieve data that is relevant to the fuel optimization for a specific request of a user. For example, structured data collection 202 may include the distance (e.g., miles, kilometers) between locations of a transit route where a vehicle may be filled with fuel. Distance data 216 may include a plurality of entries identifying two locations and the distance between the locations. In various examples, distances data 216 may include entries for stops along a transit route that has been inputted by a user (e.g., using user terminal 104). Local fuel prices data may have entries that correlate the price of fuel (e.g., per gallon, per barrel, etc.) with a location. In various examples, locations may have an identifier that is shared across data sources. Thus, an entry in distances data 216 may identify a location with the same identifier as that used in local fuel prices data 218. The data in local fuel prices data 218 may be retrieved on a periodic basis in order to have up-to-date prices. In various examples, the data collected for data fusion component 208 is considered available publically and may be collected manually or in an automated fashion (e.g., using scripts, APIs, etc.).

In various examples, vehicle characteristics such as tank capability data 220 and safety threshold data 222 includes entries on minimum and maximum capabilities of fuel in vehicles. For example, for a given vehicle there may be a minimum amount of fuel that should be in the tank for safety reasons. In various examples, this amount may be above zero. The maximum capability may include the maximum amount of fuel that the tank may support. In various examples, the maximum capability may be less than the fuel capacity of the tank of the vehicle. In various examples, a vehicle may be identified using a common identifier between tank capability data 220 and safety threshold data 222. Accordingly, if a query is inputted into computing device 204, both tank capability data 220 and safety threshold data 222 may be retrieved using the same vehicle identifier. A lookup table may also be stored that correlates a vehicle (e.g., type, make, model, etc.) with a vehicle identifier, allowing a query to use the vehicle name or other features as the input.

As discussed previously, fuel filling optimization may be treated as minimization problem with several inequality constraints. To solve this problem, difficulties are laid on the function expression of fuel consumption with respect to the amount of filled fuel and travel distance. One reason that this function is often complicated in the real world, is the varied types of vehicles. A more detailed description of optimization is described in the next sections.

In various examples, differential evolution algorithm 226 defines the problem and inequality constraints for determining the cost minimization as it relates to fuel. In an example, it is assumed that there are a total of n transfer terminals (i.e., locations in a transmit path of a vehicle) along the path. In an example, wᵢ denotes the amount of fuel filling in the i-th terminal and pᵢ denotes the local per-unit price of fuel (e.g., oil price). In this way, the fuel cost during the whole travel may be expressed as:

Cost=Σᵢ₌₁ⁿpᵢwᵢ (1)

In the above way, the fuel filling optimization problem may be treated as the minimization of the above cost function. Meanwhile, in an example, remainder fuel (e.g., oil, gas) before filling must be larger than a given threshold Tat every turn. Specifically, the amount of the remainder oil after travel from i−1 to i may be represented by Rᵢ, therefore all the constraints may be expressed as:

Rᵢ>T, i=2, 3, . . . , n

In various examples, to solve this problem, it is provided that fuel consumption model from terminal i−1 to i is represented as f (Rᵢ₋₁, wᵢ₋₁, D_{i-1,i}) which is a function of Rᵢ₋₁, wᵢ₋₁ and D_{i-1,i} (distance between terminal i−1 and i). In this way, the following function may be obtained:

Rᵢ=Rᵢ₋₁+wᵢ₋₁−f(Rᵢ₋₁,wᵢ₋₁,Dᵢ₋ₜᵢ). (2)

Therefore n−1 constraints for the minimization may be listed as:

$$\{ \begin{matrix}{w}_{1} - f ( 0 , {w}_{1} , {D}_{1 , 2} ) > T \\ {R}_{2} + {w}_{2} - f ( {R}_{2} , {w}_{2} , {D}_{2 , 3} ) > T \\ … \\ {R}_{n - 1} + {w}_{n - 1} - f ( {R}_{n - 1} , {w}_{n - 1} , {D}_{n - 1 , n} ) > T\end{matrix} \qquad ( 3 )$$

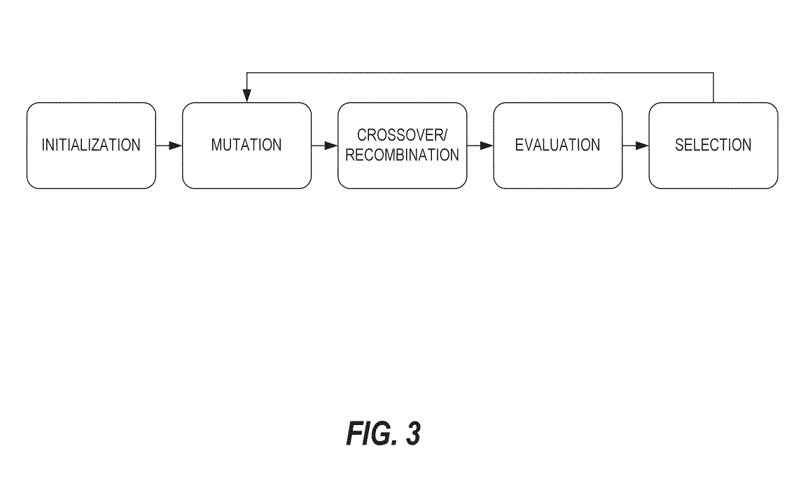

In various examples, fuel consumption models are nonlinear to wᵢ, thus this problem may be solved by using nonlinear programming methods. In various examples described herein is a generic solution to optimize the amount of fuel filling by differential evolution (DE), which is efficient for real-parameter optimization regardless specific expression of f(Rₙ₋₁, wₙ₋₁, D_{n-1,n}). Differential evolution is a population based method that optimizes a problem by iteratively trying to improve a candidate solution with regard to fitness evaluation. A flowchart of a simple DE is shown in FIG. 3.

In various examples, a DE beings with initialization (e.g., using initialization operation 214) of a plurality of chromosomes. In various examples, a chromosome may also be considered a candidate scenario. Chromosomes are interpreted as solutions of the problem, which are amount of fuel filling at each transfer terminal/location along a transmit path. In an examples, there are N chromosomes that are generated with initial values. In an embodiment, the values are random. In various examples, each chromosome contains n elements (n is the number of transfer terminals). In an example, the random values of chromosomes is limited in a range between 0 and the capacity of a fuel container for a vehicle, which is denoted as C. The capacity data may be retrieved from tank capability data 220. The random value may be a float (e.g., 1.2).

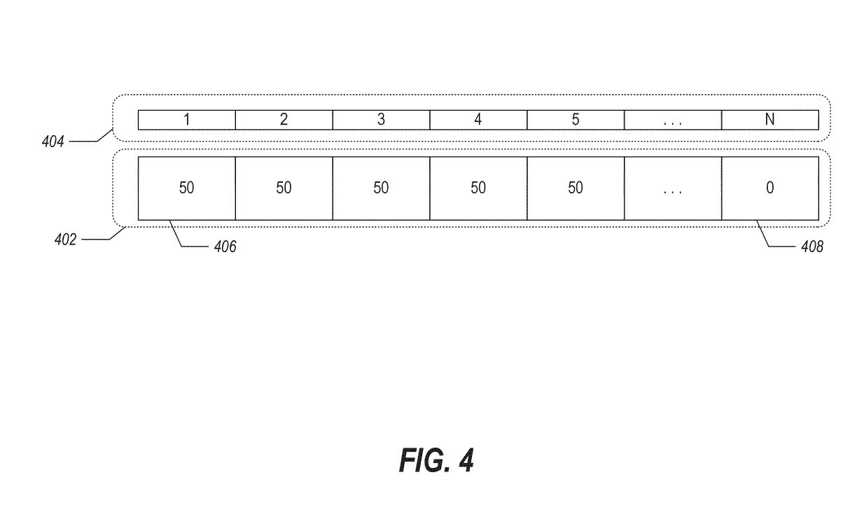

FIG. 4 illustrates a block diagram of chromosome 402, according to various examples. As illustrated, there are n genes in the chromosome. Each gene may be considered a transfer terminal along the transmit path. The value of the gene may be considered the amount of fuel to fill at that particular transfer terminal. Terminal identifiers 404 are also illustrated, which correlate with the genes. For example, gene 406 has a value of 50 and an identifier of ‘1’ and gene 408 has a value of ‘0’ and an identifier of ‘n.’ In an example, the transfer terminal identifiers increase sequentially from 1 to n. In various examples, the transfer identifier may be correlated with the location identifiers previously discussed.

In various examples, after initialization has occurred of N chromosomes, mutation operation 234 and crossover operation 236 may be performed. During the mutation operation and crossover operation the following terminologies are used:
Target vector \vec{X}_{T,G}: A parent chromosome (vector) from the current generation G;
Donor vector \vec{X}_{D,G}: A mutant vector through differential mutation operation;
Trail vector \vec{X}_{R,G}: A new vector by recombination of donor vector and target vector.
   In various examples, the donor vector is obtained from the target vector and another two randomly selected chromosomes as:

\vec{X}_{D,G}=\vec{X}_{T,G}+F·(\vec{X}_{1,G}−\vec{X}_{2,G})

where F is a scalar number and, in various examples, is set in the interval of [0.4, 1.0].

Then a binomial crossover may be implemented as

$${\vec{X}}_{R , G} = \{ \begin{matrix}{X}_{T , j , G} & rand [ 0 , 1 ] < {C}_{r} or j = {j}_{rand} \\ {X}_{D , j , G} & otherwise\end{matrix}$$

where rand[0,1] is a random number between 0 and 1, j_{rand} is a random integer number between 1 and I (I is the number of items/genes in the chromosome). X_{T,j,G} is the j-th item of target vector \vec{X}_{T,G}. In various examples, X_{D,j,G} is the j-th item of donor vector \vec{X}_{D,G}.

In various examples, an evaluation operation is utilized to evaluate the fitness of each chromosome and total cost (e.g., fuel cost evaluation 232). In the evaluation operation, the total cost of fuel may be calculated according to the chromosomes. Specifically, in an example, the i-th element of the k-th chromosome X_{k,j,G} (k=1, 2, . . . , N, i=1, 2, . . . , n) corresponds to wᵢ in Eq. (1). Therefore, a fitness function may be expressed as:

Fitness(\vec{X}_{k,G})=Σᵢ₌₁ⁿpᵢX_{k,i,G} (4)

In various examples, an infeasible solution repair operation is performed at those solutions (i.e., chromosomes) that violate the constraints in Eq. (3). In various examples, a certain percentage P (e.g., as set by a user or a default value) of high fitness infeasible chromosome (e.g., those solutions that evaluate to be better than X percentage of the other solutions) and repair them. In an example, evaluating the constraints may include checking the remainder (e.g., remainder evaluation 230) fuel of each transfer terminal sequentially according to Eq. (2). In an example, if Rᵢ<T, i=2, 3, . . . , n, Rᵢ is set to T then wᵢ₋₁ may be repaired as:

wᵢ₋₁=T−Rᵢ₋₁+f(Rᵢ₋₁,wᵢ₋₁,D_{i-1,i}). (5)

In various examples, to keep population size constant over generations, a fixed number of chromosomes are selected to the next generation based on the fitness evaluation. In various examples, it is known that there are N chromosomes in the population. After mutation and crossover processing, each target chromosome generates a trail chromosome. In other words, N associated offspring are generated. For each target and trail chromosome pair, the one with better fitness (or repaired fitness) is selected for inclusion in the next generation.

Ina various examples, the above process is completed until a stopping condition occurs. In an example, the stopping condition may be a certain number of iterations of the above process (e.g., 500 iterations). In an example, the stopping condition may be when the solutions converge. In an example, converging means that the lowest cost solution does not change over X number of iterations or does not change more than Y %. In an example, combinations of stopping conditions may be used (e.g., 500 iterations or convergence).

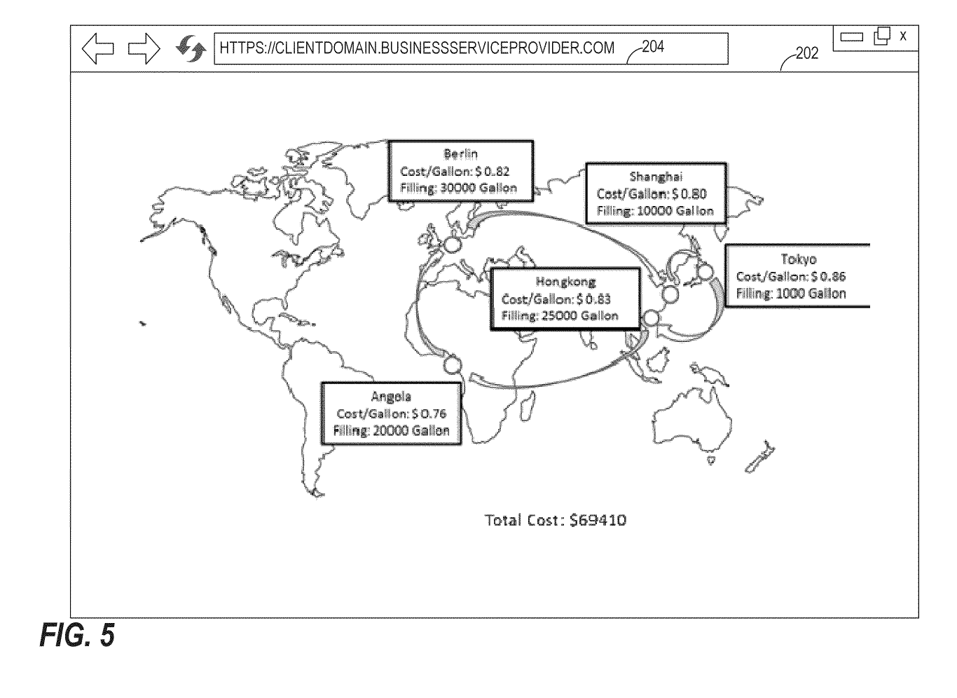

In various examples, once the stopping condition has been met, a visualization of the results may be presented to a user. Presenting may include transmitting the results for display on a user terminal. The transmitted data may include data from the lowest cost solution after differential evolution. The data may include how much fuel to use at each transfer location along a path, the cost of fuel at each transfer location, a name of each location, and a total cost. FIG. 5 illustrates a user interface of a browser window, according to various examples. Illustrated is an example of presented data overlaid on a map. More or less information may be used in presentation without departing from the scope of this disclosure. Similarly, the data may be presented in other ways such as in charts or tables.

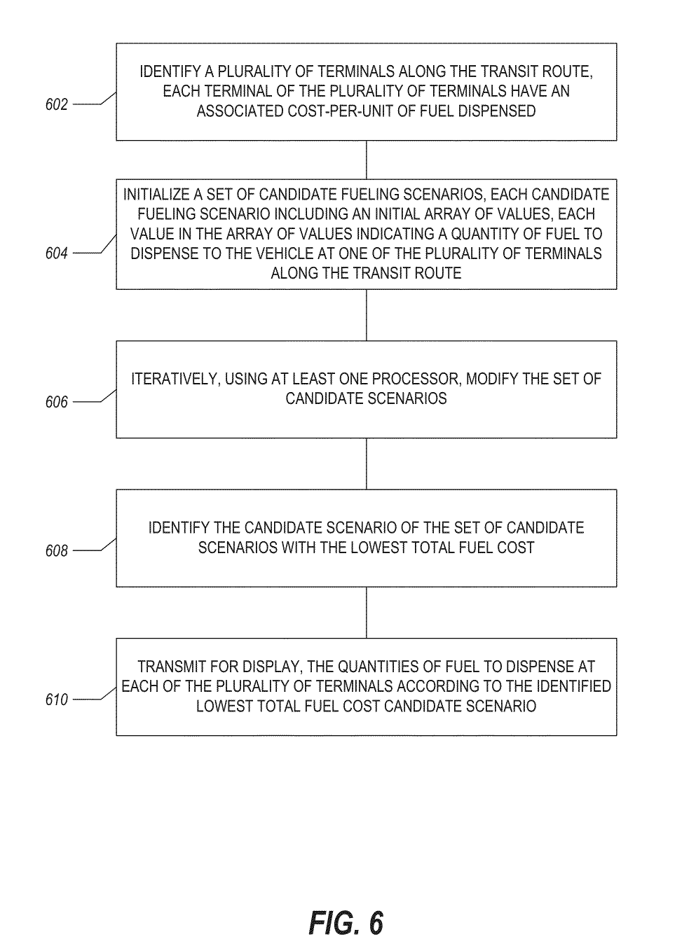

FIG. 6 is a flow chart illustrating a method 600, in accordance with various examples. The method 600 may be performed by one or more of the modules, logic, or components described herein. At block 602, according to various examples a plurality of terminals along a transit route are identified with each terminal of the plurality of terminals have an associated cost-per-unit of fuel dispensed. In various examples, the plurality of terminals are identified in a request (e.g., electronic message) to determine what quantity of fuel to fill in a vehicle at each of a plurality of terminals along the transit route. In various examples, the request originates from a user using a computing device and is transmitted to a fuel optimization system. The request may include an identification of the vehicle being used and the terminals the vehicle may be stopping at. In an example, the request may be inputted into an application running on the computing device (e.g., a web-based application or stand-alone application).

In various examples, upon receiving the request the fuel optimization system may collect data for determining the quantities of fuel to dispense into the vehicle at each terminal. For example, vehicle characteristics may be accessed for the vehicle from a database. One characteristic may be the fuel consumption function which defines the rate at which the vehicle uses fuel at various weights. The fuel consumption function may also indicate how much fuel is used over a particular distance. In other words, if a distance and starting amount of fuel are used an inputs, the fuel consumption function may output how much fuel will be left after the vehicle travels the inputted distance. Other characteristics data may include fuel capacity of the vehicle and safety thresholds for filling the fuel container of the vehicle (e.g., if the vehicle is an airplane there may be a minimum/maximum fuel levels at take-off and landing). Additionally, local fuel prices (e.g., in a cost-per unit of fuel dispensed) at each of the terminals may be retrieved, and the distances between the terminals.

At block 604, according to various examples, a set of candidate fueling scenarios is initialized. Each candidate fueling scenario may include an initial array of values, each value in the array of values indicating a quantity of fuel to dispense to the vehicle at one of the plurality of terminals along the transit route. In various examples, the initialized values are limited to the maximum fuel capacity of the vehicle as previously accessed. In an example, the initialized values are random (e.g., between 0 and the maximum fuel capacity).

At block 606, in various examples, the set of candidate scenarios is iteratively modified. For example, the candidate scenarios may be modified using a differential evolution method as discussed above. For example, the candidate scenarios may each go through mutation and crossover operations. Additionally, infeasible candidate scenarios may be repaired (e.g., changing a value in the array to meet safety thresholds, etc.). Determining whether a candidate is infeasible may include examining the values of the array against the safety threshold for the vehicle at each stop as well as using the fuel consumption function to make sure there is enough fuel to arrive at each terminal. In various examples, the resulting candidate scenarios may be compared against the original candidate scenarios to determine the most fit (e.g., lowest total cost) scenarios. The process of mutation and cross over may be repeated until a stopping condition occurs. The stopping condition may be set according to the user who submitted the request or by the fuel optimization system.

At block 608, the lowest total fuel cost candidate scenario of the set of candidate fueling scenarios is identified according to various examples. For example, a fitness value of each candidate scenario in the set may be calculated based on the cost of fuel at each of the plurality of terminals and the array of values in a respective candidate scenario. For example, the fitness value for a respective candidate scenario may be based on, for each terminal, multiplying the retrieved fuel cost for a terminal by the value in the array associated with that terminal, and then summing these values. According to various examples, the lowest total fuel cost scenario is the scenario with the lowest fitness value.

At block 610, according to various examples, the quantities of fuel to dispense in the vehicle at each of the plurality of terminals according to the identified lowest total fuel cost candidate scenario are transmitted for display. For example, the quantities may be transmitted back to the computing device from which the request was received and displayed in a graphical format.

In various examples, the following pseudo code may be used for fuel cost optimization:

| | % NumOfChrom: number of chromosomes in DE population |
|---|---|
| | % LenOfIndiv: length of individual (the number of items) |
| | % Population: all the chromosomes of a generation |
| | % F: scalar number for mutation |
| | % CrosRate: crossover rate |
| | % TargetChrom: target chromosome |
| | % DonChrom: donor chromosome |
| | % TrailChrom: trail chromosome |
| | % RandChrom1: Randomly selected chromosome 1 |
| | % RandChrom2: Randomly selected chromosome 2 |
| 1. | FUNCTION OPTIMIZATION |
| 2. | BEGIN |
| | % ============ Initialization ============ |
| 3. | Initialize NumOfChrom chromosomes as Population randomly |
| | % ============ End Initialization ======== |
| 4. | WHILE not converge |
| 5. | FOR EACH chromosome IN Population |

| | |
|---|---|
| | % ============Mutation============ |
| 6. | TargetChrom = Chromosome |
| 7. | Randomly select RandChrom1 and RandChrom2 from |
| | population besides |

TargetChrom

| | |
|---|---|
| 8. | DonChrom = TargetChrom + F*(RandChrom1 − RandChrom2) |
| | % ===========End Mutation=========== |
| | % ============ Crossover============= |
| 9. | FOR j = 1 : LenOfIndiv |
| 10. | Rand = Randomly generate a real number in [0,1] |
| 11. | j_{rand} = Randomly generate an integer number in |
| | [1, LenOfIndiv] |
| 12. | IF (Rand < CrosRate) OR (j = j_{rand}) |

| | |
|---|---|
| 13. | TrailChrom[j] = DonChrom[j] |

| | |
|---|---|
| 14. | ELSE |

| | |
|---|---|
| 15. | TrailChrom[j] = TargetChrom[j] |

| | |
|---|---|
| 16. | ENDIF |
| 17. | ENDFOR |
| | % ===========End Crossover============ |
| | % =========Repair and evaluate========= |
| 18. | Repair infeasible chromosome by Eq. (5) |
| 19. | Evaluate both the TargetChrom and TrailChrom by Eq. (4) |
| | % =============Selection============= |
| 20. | IF Fitness(TargetChrom) ≦ Fitness(TrailChrom) |
| 21. | Chromosome = TrailChrom |
| 22. | ELSE |
| 23. | Chromosome = TargetChrom |
| 24. | ENDIF |
| | % =============End Selection============ |

| | |
|---|---|
| 25. | END FOR EACH |
| 26. | Update Chromosomes as the next generation |
| 27. | END WHILE |
| 28. | END BEGIN |

Certain embodiments are described herein as including logic or a number of components, modules, or mechanisms. Modules/components, etc may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

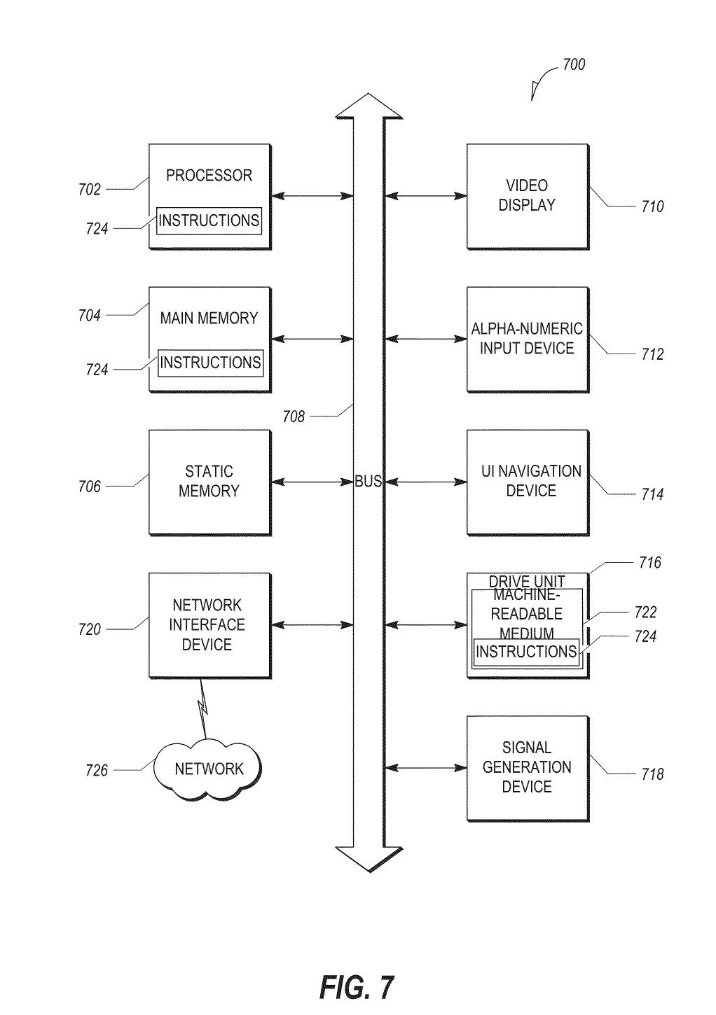

FIG. 7 is a block diagram of a machine in the example form of a computer system 700 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method for determining quantities of fuel to dispense at a plurality of terminals along a transit route of a vehicle, the method comprising:
identifying a plurality of terminals along the transit route, each terminal of the plurality of terminals have an associated cost-per-unit of fuel dispensed;
initializing a set of candidate fueling scenarios, each candidate fueling scenario including an initial array of values, each value in the array of values indicating a quantity of fuel to dispense to the vehicle at one of the plurality of terminals along the transit route;
iteratively, using at least one processor, modifying the set of candidate scenarios;
identifying the candidate scenario of the set of candidate scenarios with the lowest total fuel cost; and
transmitting for display, the quantities of fuel to dispense at each of the plurality of terminals according to the identified lowest total fuel cost candidate scenario.

2. The method of claim 1, wherein iteratively, using the at least one process, modifying the set of candidate scenarios comprises:
modifying the set of candidate scenarios based on the differential evolution method.

3. The method of claim 1, wherein identifying the candidate scenario of the set of candidate scenarios with the lowest total fuel cost comprises:
calculating, using the least one processor, a fitness value of each candidate scenario based on the cost-per-unit of fuel dispensed at each of the plurality of terminals and the array of values in a respective candidate scenario.

4. The method of claim 1, further comprising:
receiving an identification the vehicle; and
accessing vehicle characteristics of the vehicle from a database based on the identification.

5. The method of claim 4, wherein initializing the set of candidate fueling scenarios comprises:
accessing the vehicle characteristics to determine the maximum fuel capacity for the type of vehicle; and
limiting the initial array of values to the maximum fuel capacity.

6. The method of claim 5, wherein the initial array of values is random.

7. The method of claim 4, further comprising:
accessing the vehicle characteristics to determine safety fuel thresholds of the vehicle; and
evaluating the feasibility of each candidate fueling scenario according to safety fuel thresholds of the vehicle.

8. The method of claim 7, wherein the vehicle is an airplane and a safety fuel threshold of the vehicle identifies a minimum amount of fuel for the vehicle for landing at each terminal.

9. The method of claim 7, further comprising:
repairing a candidate fueling scenario of the set of candidate fueling scenarios when the evaluation indicates the candidate scenario is infeasible.

10. The method of claim 9, wherein repairing a candidate fueling scenario comprises modifying a value in the array of values for the candidate fueling scenario in accordance with the safety fuel thresholds.

11. The method of claim 4, further comprising:
accessing the vehicle characteristics to determine a fuel consumption function for the vehicle;
evaluating the feasibility of each candidate fueling scenario according to fuel consumption function of the vehicle to determine that there is enough fuel at each terminal to arrive at the next terminal along the transit route.

12. The method of claim 1, wherein iteratively, using at least one processor, modifying the set of candidate scenarios comprises:
selecting one of the candidate fueling scenarios of the set of candidate fueling scenarios as a target candidate fueling scenario; and
generating a mutated candidate fueling scenario based on the target candidate fueling scenario and two other randomly selected candidate fueling scenarios from the set of candidate fueling scenarios.

13. The method of claim 12, further comprising:
generating a crossover candidate fueling scenario based on the mutated candidate fueling scenario and a randomly generated number.

14. A system for determining quantities of fuel to dispense at a plurality of terminals along a transit route of a vehicle, the system comprising:
one or more processors;
a storage device with instructions stored thereon; and
wherein when the instructions are executed by the one or more processors, the one or more processors are configured to perform operations comprising:
identifying a plurality of terminals along the transit route, each terminal of the plurality of terminals have an associated cost-per-unit of fuel dispensed;
initializing a set of candidate fueling scenarios, each candidate fueling scenario including an initial array of values, each value in the array of values indicating a quantity of fuel to dispense to the vehicle at one of the plurality of terminals along the transit route;
iteratively, using at least one processor, modifying the set of candidate scenarios;
identifying the candidate scenario of the set of candidate scenarios with the lowest total fuel cost; and
transmitting for display, the quantities of fuel to dispense at each of the plurality of terminals according to the identified lowest total fuel cost candidate scenario.

15. The system of claim 14, wherein the operation of iteratively, using the at least one process, modifying the set of candidate scenarios comprises:
modifying the set of candidate scenarios based on the differential evolution method.

16. The system of claim 14, wherein the operation of identifying the candidate scenario of the set of candidate scenarios with the lowest total fuel cost comprises:
calculating, using the least one processor, a fitness value of each candidate scenario based on the cost-per-unit of fuel dispensed at each of the plurality of terminals and the array of values in a respective candidate scenario.

17. The system of claim 1, wherein the operations comprise:
receiving an identification the vehicle; and
accessing vehicle characteristics of the vehicle from a database based on the identification.

18. The system of claim 17, wherein the operation of initializing the set of candidate fueling scenarios comprises:
accessing the vehicle characteristics to determine the maximum fuel capacity for the type of vehicle; and
limiting the initial array of values to the maximum fuel capacity.

19. A non-transitory computer-readable medium comprising instructions, which when executed by at least one processor, configure the at least one process to perform operations comprising:
identifying a plurality of terminals along a transit route, each terminal of the plurality of terminals have an associated cost-per-unit of fuel dispensed;
initializing a set of candidate fueling scenarios, each candidate fueling scenario including an initial array of values, each value in the array of values indicating a quantity of fuel to dispense to a vehicle at one of the plurality of terminals along the transit route;
iteratively, using at least one processor, modifying the set of candidate scenarios;
identifying the candidate scenario of the set of candidate scenarios with the lowest total fuel cost; and
transmitting for display, the quantity of fuel to dispense at each of the plurality of terminals according to the identified lowest total fuel cost candidate scenario.

20. A method comprising:
receiving a request to determine quantities of fuel to dispense in a vehicle at each of a plurality of terminals for the vehicle along the transit route, each terminal of the plurality of terminals have an associated cost-per-unit of fuel dispensed;
initializing a set of candidate fueling scenarios, each candidate fueling scenario including an initial array of values, each value in the array of values indicating a quantity of fuel to dispense to the vehicle at one of the plurality of terminals along the transit route;
for each candidate fueling scenario:
generating a mutated candidate fueling scenario based on the target candidate and two other randomly selected candidate fueling scenarios from the set of candidate fueling scenarios;
generating a crossover candidate fueling scenario based on the mutated candidate and a randomly generated number; and
choosing between the crossover candidate fueling scenario and the respective candidate fueling scenario to remain in the set of candidate fueling scenarios based on a calculated fitness value of the crossover candidate fueling scenario and the respective candidate fueling scenario;
iteratively repeating the generating of mutated candidate fueling scenarios and crossover candidates until a stopping condition occurs; and
based on the stopping condition occurring, identifying the lowest total cost candidate scenario of the set of candidate fueling scenarios based on the calculated fitness values; and
transmitting for display, the quantities of fuel to dispense at each of the plurality of terminals based on the identified lowest total fuel cost candidate scenario.
